(19) United States
(12) Patent Application Publication
(10) Pub. No.: US 2019/0034743 A1
(43) Pub. Date: Jan. 31, 2019

(54) DASHBOARD EMBEDDED DRIVER MONITORING SYSTEM

(71) Applicants: Benoit Chauveau, Van Buren Township, MI (US); Jean Luc Croy, Van Buren Township, MI (US)

(72) Inventors: Benoit Chauveau, Van Buren Township, MI (US); Jean Luc Croy, Van Buren Township, MI (US)

(21) Appl. No.: 15/660,326

(22) Filed: Jul. 26, 2017

(51) Int. Cl. G06K 9/00; G02B 7/02; H04N 7/18

(52) U.S. Cl. CPC G06K 9/00845; H04N 7/185; G02B 7/02

(57) ABSTRACT

Disclosed herein are devices, methods and systems for an embedded driver monitoring system for employment in a vehicle. The aspects disclosed herein employ a strategically placed reflective lens along with a camera, the camera being coupled to the driver monitoring system. The aspects disclosed herein describe the actual implementation of the camera/lens arrangement, as well as the method for implementing said systems/devices.

### BACKGROUND

Driver monitoring systems are employed in vehicles to ensure that a driver is awake, alert, or generally orienting their attention to the front portion of the vehicle. If a driver falls asleep, or does not pay attention to oncoming traffic or road conditions, the probability of the vehicle/driver being in an accident or causing an accident increases.

In recent times, various driver monitoring systems have been implemented. These systems allow for monitoring the driver, for example whether the driver's eyes are closed, are blinking, or if the driver's head is oriented towards a mobile device and generally not in a direction forward or appropriate for driving. Thus, the driver monitoring systems may record violations, such as those enumerated above, and alert the driver, engage an autonomous driving function, or notify a third-party.

In order to implement these systems, a camera and other devices have to be situated in the vehicle cockpit area. A vehicle cockpit is defined as the area in a front of vehicle that includes the dashboard, infotainment system, instrument cluster and other peripherals included in the front portion of the vehicle. However, in adding elements to the vehicle cockpit system, the overall look and aesthetics associated with the vehicle may be lessened due to the addition of an unsightly element.

One such optical system currently employed in some applications is a mirascope 100. FIGS. 1(a)-(c) illustrates a mirascope 100 according to a prior art implementation. In FIG. 1(a), a cross-sectional view of the mirascope 100 is depicted.

As shown in FIG. 1(a), two concave mirrors 110 and 120/130 (with aperture 125) are placed together, with the concave portions facing each other. The upper concave mirror, includes a first part 120, an aperture 125, and a second part 130.

As shown, an object 140a is placed on the bottom mirror 110. The object 140a, when lighted, reflects light 150 of all the surfaces of the bottom mirror 110, and the top mirrors 120/130. This produces an effect of a three-dimensional virtual image 140b.

This effect is shown in greater detail with regards to FIGS. 1(b) and (c). As shown in FIG. 1(b), a three-dimensional image 140b of a frog is shown. In FIG. 1(c), a FIG. 160 is shown to indicate that in the aperture 125, there image is optically real but not tangible.

### SUMMARY

The following description relates to providing a system, method, and device for implementing a dashboard embedded driver monitoring system. Exemplary embodiments may also be directed to any of the system, the method, or an application disclosed herein, and the subsequent implementation in a vehicle during a driving state.

The exemplary embodiments disclosed herein are directed to a vehicle cockpit of a vehicle with a driver monitoring system. The system includes a dashboard of the vehicle; an aperture formed on the dashboard; a cavity housing formed within the dashboard and oriented with the aperture; a reflective lens disposed within the cavity; and a camera oriented at the reflective lens, the camera being electrically coupled to the driver monitoring system.

In another example, the dashboard includes a surface, the surface opposing a front window of the vehicle.

In another example, the system includes a reflective lens is disposed at an angle over 90 degrees with the aperture.

In another example, the system includes a transparent surface over the aperture.

In another example, the reflective lens is oriented at an occupant/driver of the vehicle and the camera.

In another example, the reflective lens is flat.

In another example, the reflective lens is curved.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIGS. 1(a)-(c) illustrates a concept of mirascope presentation according to a prior art implementation;

FIG. 2 illustrates an implementation of an embedded camera/lens-based system for implementing the aspects disclosed herein;

FIGS. 3(a) and (b) illustrate the advantages obtained by implementing the system of FIG. 2;

FIG. 4 illustrates a vehicle-based cockpit implementing system of FIG. 2; and

FIG. 5 illustrates a method of implementation of the system in FIG. 2.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

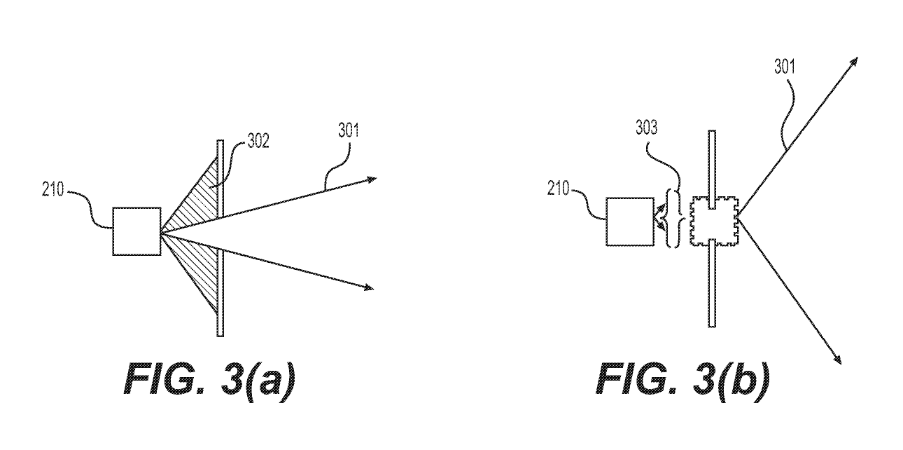

As explained in the Background section, implementing driver monitoring systems may be difficult due to demands to not add elements to a vehicle cockpit area. In some implementations, a camera may be embedded therein. However, as the camera is embedded within the dashboard, the area where the camera's lens is situated may be obscured from obtaining a whole view of the area outside of the dashboard (this phenomenon is explained in greater detail below, and highlighted in FIG. 3(a)).

Disclosed herein are implementations to provide a dashboard embedded driver monitoring system. By employing the aspects disclosed herein, vehicular cockpits may be more aesthetically pleasing, employ additional areas not previously utilized, and incorporate a wholly new way of implementing said systems.

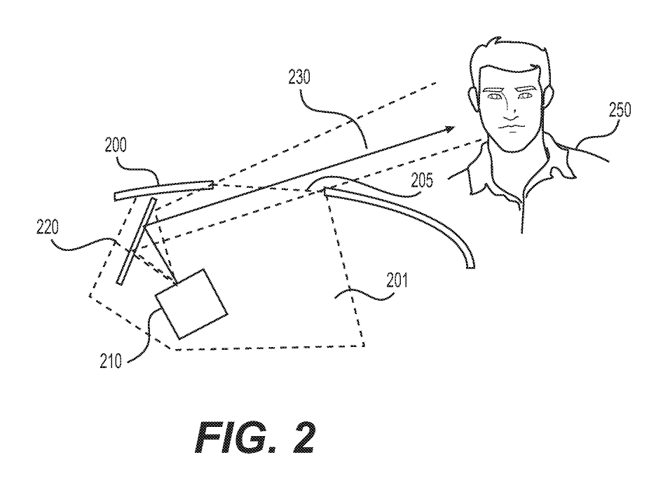

FIG. 2 illustrates an implementation of a driver monitoring system according to the aspects disclosed herein. As shown, a driver/occupant of the vehicle 250 is situated in area associated with a front of the vehicle.

The only portion of the front of the vehicle shown is the dashboard 200. The dashboard 200 extends substantially perpendicular to the front windshield (not shown). The dashboard 200 includes an aperture 205.

Embedded in the dashboard area is a cavity 201. The cavity 201 is shaped similar to and to conform to at least half the volume of a mirascope, such as the one explained above in the Background section. The cavity may be introduced into a dashboard area of the vehicle. The size and shape of the cavity is made to allow the placement and provision of camera 210, and the necessary wiring associated with said camera (or alternatively, through wire-less coupling).

Internally disposed in the cavity 201 are a camera 210 and a reflective lens 220. The camera 210 is any image or video capturing device oriented first at the lens 220, and ultimately (through the reflective properties of the lens 220) out through the aperture 205, and presumably at the occupant 250. Thus, employing path 230, the camera 210 is able to capture images/videos of the occupant 230 and be integrated into various driver monitoring systems.

The lens 220 may be any lens capable of capturing said image of occupant 250. Ideally, the lens 220 should be oriented at an angle away from the aperture 205 (greater than 90 degrees). This allows the lens 220 to be able to capture the area outside of the aperture 205, as well as the camera 210.

Thus, employing the setup shown in FIG. 2, a larger view of the occupant is effectively captured occupant is effectively captured. Implementations with and without the aspects disclosed herein are explained in greater detail in FIGS. 3(a) and (b).

FIG. 3(a) illustrates an implementation without the benefit of the lens-based approached introduced in exemplary embodiments disclosed herein. As shown, a camera 210 is disposed near and around an aperture. The camera's visual path 301 is also shown. Due to spacing associated with an aperture 205 and the camera, significant portions of the area 302 are not captured. As such, an implementation shown in FIG. 3(a) is effectively frustrated.

On the contrary, FIG. 3(b) illustrates employment of the concepts discussed herein. As shown, the placement of a lens 220 near an aperture 205 (optical system 303), in the configuration shown in FIG. 2, creates an ability to capture a greater area 301 on the side on which the camera is situated.

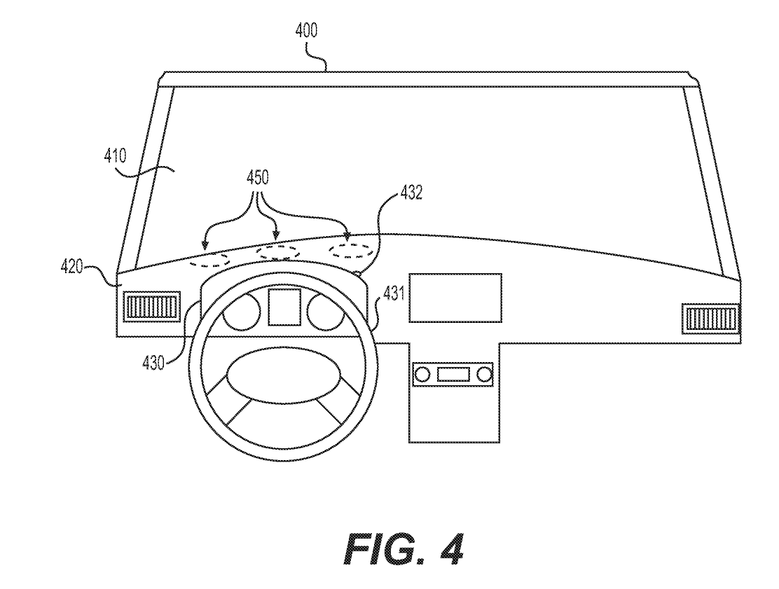

FIG. 4 illustrates a cockpit/dashboard 420 implementation in a vehicle 400. As shown, the vehicle 400 includes a front windshield 410. The front windshield 410 is substantially transparent. In other embodiments, the front windshield 410 may be incorporated with electronic display capabilities, and convey electrical information to the occupant/driver of the vehicle 400.

The cockpit/dashboard 420 also includes several components standard to most vehicles. As shown, there is an instrument cluster 430, a steering wheel 431, various buttons/human machine interfaces (HMI) devices 432, and other components shown.

Additionally provided are transparent windows 450. Three are shown, but the number implemented is exemplary. The number and location may be chosen by an implementer of the aspects disclosed herein. Implemented within the dashboard 420, and under the transparent window 450 is the device/system shown in FIG. 2. In some embodiments, the implementation may be merely an aperture 205. In other embodiments, the implementation may be a transparent dust cover.

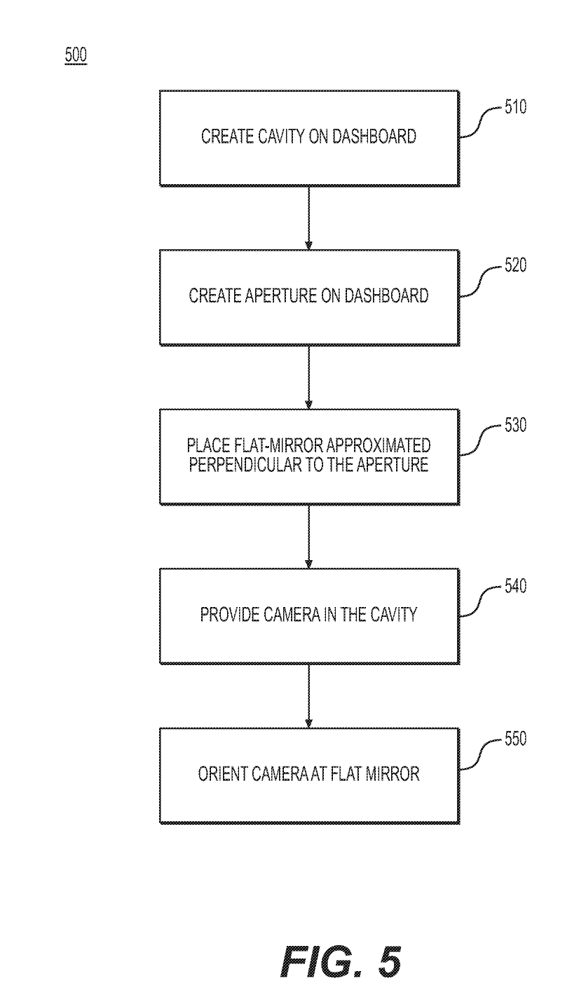

FIG. 5 illustrates a method 500 of implementing the aspects disclosed herein. In operation 510, a cavity is created in the dashboard area (such as transparent window 450). An existing dashboard 420 may be modified to include said cavity. Alternatively, an aperture 205 may be created, with the cavity already existing in said dashboard (operation 520).

In operation 530, a flat mirror 220 is placed in the cavity 201, as shown in FIG. 2. The flat mirror 220 is approximately perpendicular (however, angled to be greater than 90 degrees) with the aperture 205. The flat mirror 220 is provided to capture a face disposed in an area outside of the cavity while presenting images (via reflection) to the camera 210 disposed with in the cavity.

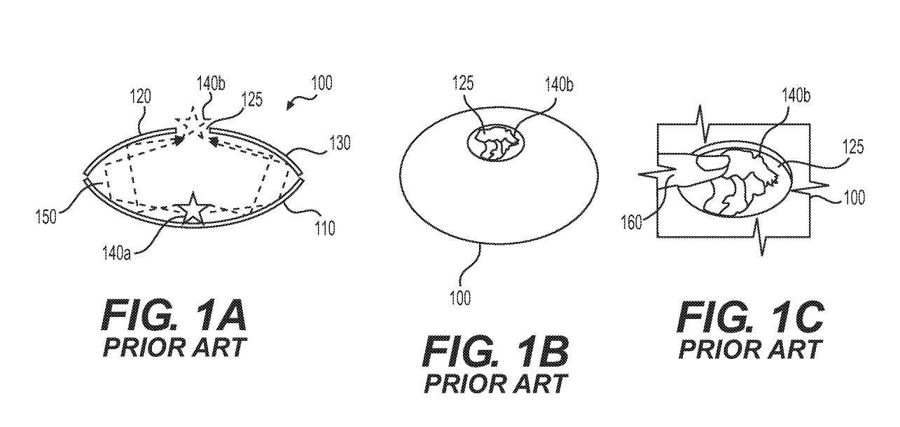

Alternatively, the flat mirror 220 may be in a curved shape conforming with the shape of the embedded area shown in FIGS. 1(a)-(c).

In operation 540, a camera 210 is disposed in the cavity, and oriented at the flat mirror 220 (operation 550). The camera 210 may be electrically coupled to a driver monitor system (not shown).

Thus, employing the aspects disclosed herein, a camera for employment with a driver monitoring system (such as those known in the art) may be effectively hidden and in an area not visible to an occupant/driver of a vehicle. Further, employing the exact orientation of lenses and camera disclosed herein allows for a more effective field of view associated with said monitoring.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. A vehicle cockpit of a vehicle with a driver monitoring system, comprising:
a dashboard of the vehicle;
an aperture formed on the dashboard;
a cavity housing formed within the dashboard and oriented with the aperture;
a reflective lens disposed within the cavity; and
a camera oriented at the reflective lens, the camera being electrically coupled to the driver monitoring system.

2. The cockpit according to claim 1, wherein the dashboard includes a surface, the surface opposing a front window of the vehicle.

3. The cockpit according to claim 1, wherein the reflective lens is disposed at an angle over 90 degrees with the aperture.

4. The cockpit according to claim 1, further comprising a transparent surface over the aperture.

5. The cockpit according to claim 1, wherein the reflective lens is oriented at an occupant/driver of the vehicle and the camera.

6. The cockpit according to claim 1, wherein the reflective lens is flat.

7. The cockpit according to claim 1, wherein the reflective lens is curved.
